(19) United States
(12) Patent Application Publication
(10) Pub. No.: US 2024/0120862 A1
(43) Pub. Date: Apr. 11, 2024

(54) CLOSED-LOOP CONTROL DEVICE FOR CLOSED-LOOP CONTROL OF A POWER ASSEMBLY INCLUDING AN INTERNAL COMBUSTION ENGINE AND A GENERATOR HAVING AN OPERATIVE DRIVE CONNECTION TO THE INTERNAL COMBUSTION ENGINE, CLOSED-LOOP CONTROL ARRANGEMENT HAVING SUCH A CLOSED-LOOP CONTROL DEVICE, POWER ASSEMBLY AND METHOD FOR CLOSED-LOOP CONTROL OF A POWER ASSEMBLY

(71) Applicant: Rolls-Royce Solutions GmbH, Friedrichshafen (DE)

(72) Inventors: Armin Dölker, Friedrichshafen (DE); Johannes Baldauf, Wangen (DE)

(73) Assignee: Rolls-Royce Solutions GmbH, Friedrichshafen (DE)

(21) Appl. No.: 18/536,894

(22) Filed: Dec. 12, 2023

Related U.S. Application Data
(63) Continuation of application No. PCT/EP2022/066835, filed on Jun. 21, 2022.

(30) Foreign Application Priority Data
Jun. 22, 2021 (DE) 10 2021 206 419.1
Jun. 21, 2022 (WO) PCT/EP2022/066835

(51) Int. Cl. H02P 9/04; F02D 29/06; F02D 41/14

(52) U.S. Cl. CPC H02P 9/04; F02D 29/06; F02D 41/1401; F02D 2250/18; H02P 2101/25

(57) ABSTRACT

A closed-loop control device includes:
a power controller for:
   detecting a generator power of a generator as a controlled variable,
   determining a power control deviation as a difference between the detected generator power and a target generator power; and
   determining a first preset variable as a function of the power control deviation;
a frequency controller for:
   detecting a generator frequency of the generator as a controlled variable,
   determining a frequency control deviation as a difference between the detected generator frequency and a target generator frequency;
   determining a second preset variable as a function of the frequency control deviation; and
a preselection module for determining a third preset variable,
the closed-loop control device for:
   combining the first preset variable, the second preset variable, and the third preset variable with one another to form an overall preset variable; and
   using the overall preset variable for controlling an internal combustion engine.

### CROSS REFERENCE TO RELATED APPLICATIONS

This is a continuation of PCT application no. PCT/EP2022/066835, entitled “CLOSED-LOOP CONTROL DEVICE FOR CLOSED-LOOP CONTROL OF A POWER ASSEMBLY COMPRISING AN INTERNAL COMBUSTION ENGINE AND A GENERATOR HAVING AN OPERATIVE DRIVE CONNECTION TO THE INTERNAL COMBUSTION ENGINE, CLOSED-LOOP CONTROL ARRANGEMENT HAVING SUCH A CLOSED-LOOP CONTROL DEVICE, POWER ASSEMBLY AND METHOD FOR CLOSED-LOOP CONTROL OF A POWER ASSEMBLY”, filed Jun. 21, 2022, which is incorporated herein by reference. PCT application no. PCT/EP2022/066835 claims priority to German patent application no. 10 2021 206 419.1, filed Jun. 22, 2021, which is incorporated herein by reference.

### BACKGROUND OF THE INVENTION

### 1. Field of the Invention

The present invention relates to a closed-loop control device, and, more particularly, to a closed-loop control device for closed-loop control of a power assembly.

### 2. Description of the Related Art

Such a closed-loop control device can be designed to provided closed-loop control of a generator power or a generator frequency of the generator of a power assembly. Difficulties arise in particular if both the generator power and the generator frequency are to be controlled. It has proven to be difficult in particular here to implement good load switching behavior, on the one hand, and robust, stable closed-loop control, on the other hand. While these goals are already contradictory as such, the problem becomes more severe in the case outlined here because two different variables are to be controlled.

What is needed in the art is a closed-loop control device for closed-loop control of a power assembly including an internal combustion engine and a generator having an operative drive connection to the internal combustion engine, a closed-loop control arrangement including such a closed-loop control device, a power assembly including an internal combustion engine and a generator having an operative drive connection to the internal combustion engine, including a closed-loop control device of this kind or including a closed-loop control arrangement of this kind, and a method for closed-loop control of a power assembly of this kind, wherein the described disadvantages are at least reduced and optionally do not occur.

### SUMMARY OF THE INVENTION

The invention relates to a closed-loop control device for closed-loop control of a power assembly including an internal combustion engine and a generator having an operative drive connection to the internal combustion engine, to a closed-loop control arrangement including such a closed-loop control device, to a power assembly including an internal combustion engine and a generator having an operative drive connection to the internal combustion engine, including a closed-loop control device of this kind or including a closed-loop control arrangement of this kind, and to a method for closed-loop control of a power assembly of this kind.

The present invention provides a closed-loop control device for closed-loop control of a power assembly, wherein the power assembly has an internal combustion engine and a generator having an operative drive connection to the internal combustion engine. The closed-loop control device has a power controller which is set up to detect a generator power of the generator as a controlled variable, to determine a power control deviation as the difference between the detected generator power and a target generator power, and to determine a first preset variable as a function of the power control deviation. The closed-loop control device additionally has a frequency controller, which is set up to detect a generator frequency of the generator as a controlled variable, to determine a frequency control deviation as the difference between the detected generator frequency and a target generator frequency, and to determine a second preset variable as a function of the frequency control deviation. The closed-loop control device additionally has a preselection module, which is set up to determine a third preset variable—in particular as a preselection variable for controlling the internal combustion engine. The closed-loop control device is set up to combine the first preset variable, the second preset variable, and the third preset variable with one another to form an overall preset variable, in particular to offset them, and to use the overall preset variable—in particular as a manipulated variable—for controlling the internal combustion engine. In the closed-loop control device proposed here, changes in the operation of the power assembly, in particular changes of at least one target variable, in particular changes of the target generator power, are advantageously implemented directly by the preselection module in changes of the preselection variable, i.e., the third preset variable, wherein they also cause a change of the manipulated variable by offsetting the third preset variable with other preset variables to form the overall preset variable. The closed-loop control device proposed here therefore has very good load switching behavior. At the same time, however, the closed-loop control device proposed here also has robust, stable closed-loop control of both the generator power and the generator frequency, since dynamic requirements are met by the preselection, so that stable and robust parameterization can be selected in each case for the power controller and for the frequency controller, even if these are possibly accompanied by a slower closed-loop control characteristic. In particular, it is possible that the overall preset variable, i.e., in particular the resulting manipulated variable for controlling the internal combustion engine, is calculated for each sampling step in consideration in each case of the manipulated variables of the power controller and the frequency controller, i.e., from the first preset variable and the second preset variable of the respective sampling step, so that no sampling-related dead times arise. It is therefore possible to react immediately, with high closed-loop control speed, to changes of the generator frequency and the generator power.

In the context of the present technical teaching, a generator frequency is understood in particular to be the frequency of the electrical voltage induced in the generator, in particular the frequency of the electrical output voltage of the generator.

In particular, the closed-loop control device is set up to control the generator power and the generator frequency simultaneously, i.e., at the same time. This is possible in particular due to the offsetting of the first preset variable, the second preset variable, and the third preset variable with one another to form the overall preset variable, which can in particular take place in each individual sampling step for each individual preset variable.

In one embodiment, the closed-loop control device is set up to output the overall preset variable—in particular as a manipulated variable—for controlling the internal combustion engine. In particular, the closed-loop control device is set up to use the overall preset variable—in particular as a manipulated variable—for controlling the internal combustion engine, in that it outputs the overall preset variable. The closed-loop control device optionally has an interface which is set up to output the overall preset variable.

In another embodiment, the closed-loop control device is set up to convert the overall preset variable into a control variable, wherein the control variable is suitable for directly controlling the internal combustion engine. In this case, the overall preset variable is used indirectly for controlling the internal combustion engine. In particular, the closed-loop control device is optionally set up to output the control variable. In particular, the closed-loop control device optionally has an interface, which is set up to output the control variable.

The closed-loop control device is optionally set up to calculate the same type of preset variable, i.e., in particular the same physical variable, for the first preset variable, the second preset variable, and the third preset variable. In particular, the first preset variable, the second preset variable, and the third preset variable are each an identical physical variable. In this way, they can be combined with one another particularly easily, in particular offset, in particular added to one another or summed. In particular, it is possible that all three preset variables are a torque.

The term “preselection module” in the context of the present technical teaching designates in particular a functional relationship, which is set up to determine the third preset variable—in particular as a preselection variable. The preselection module does not necessarily have to be a unit that can be delimited technically or conceptually from other parts of the closed-loop control device; rather this term combines all of those technical and/or functional structures of the closed-loop control device which interact with one another in order to determine the third preset variable. The preselection module can form a functional unit here, but this is not necessarily the case. The preselection module can be present as a hardware module in the closed-loop control device, but it is also possible that the preselection module is implemented in software in the closed-loop control device.

The closed-loop control device is optionally set up to work in discrete time, in particular to carry out its calculations in discrete time, i.e., in particular in clocked fashion. The resulting discrete points in time are also referred to in the context of the present technical teaching as sampling steps. The clocking is also referred to as sampling.

A power assembly is understood here in particular to be an arrangement consisting of an internal combustion engine and an electric machine operable as a generator, that is to say, a generator, wherein the internal combustion engine has an operative drive connection to the generator in order to drive the generator. Thus, the power assembly is set up in particular to convert chemical energy converted into mechanical energy in the internal combustion engine into electrical energy in the generator. The power assembly can be operated alone—in so-called island operation—or also together with a plurality of—in particular a small number of—other power assemblies in a network, i.e., in island parallel operation. However, it is also possible that the power assembly is operated on a, in particular, larger power grid or energy supply grid, in particular a supra-regional power grid, in grid parallel operation.

The closed-loop control device is optionally set up to filter an instantaneous actual frequency of the generator and to use the filtered actual frequency as the detected generator frequency. This advantageously enables particularly quiet and therefore robust closed-loop control. The instantaneous actual frequency is optionally measured directly at the generator. According to an optional embodiment, the instantaneous actual frequency is filtered using a PT₁ filter or mean value filter, wherein the detected generator frequency results from the PT₁ filter or mean value filter.

The closed-loop control device is optionally set up to limit the instantaneous actual frequency or the filtered actual frequency to a predetermined minimum frequency as a lower limit, by which a limited generator frequency is obtained. The closed-loop control device is additionally set up to use the limited generator frequency as the detected generator frequency.

The closed-loop control device is alternatively or additionally optionally set up to filter an instantaneous actual power of the generator and to use the filtered actual power as the detected generator power. This advantageously enables particularly quiet and therefore robust closed-loop control. The instantaneous actual power is optionally measured—optionally electrically—directly at the generator. According to an optional embodiment, the instantaneous actual power is filtered using a PT₁ filter or a mean value filter, wherein the detected generator power results from the PT₁ filter or mean value filter.

A closed-loop control device is understood to mean, in particular, a feedback control device. Correspondingly, a closed-loop control arrangement is understood to mean, in particular, a feedback control arrangement. Accordingly, an open-loop control device is understood to mean, in particular, a non-feedback control device.

According to a development of the present invention, it is provided that the closed-loop control device is set up to add the first preset variable, the second preset variable, and the third preset variable to one another to form the overall preset variable. This represents a both simple and advantageous embodiment of the closed-loop control device. In particular, the addition of the preset variables to form the overall preset variable enables a dynamic preselection with robust closed-loop control of the generator power and the generator frequency at the same time. In particular, the first and second output variable calculated by the power controller and the frequency controller are advantageously superimposed correctively on the third output variable calculated by the preselection module.

According to a development of the present invention, it is provided that the preselection module is set up to determine the third preset variable on the basis of a target generator power variable. In this way, changes of the target generator power are transferred without delay, i.e., with a high level of dynamics, to the overall preset variable. This in turn causes very good load switching behavior of the closed-loop control device proposed here. The use of the target generator power variable for determining the third preset variable is advantageous in particular since the target generator power typically varies more strongly in operation of the closed-loop control device than the target generator frequency. The preselection module is optionally set up to determine the third preset variable on the basis of the target generator power variable and the detected generator frequency.

The target generator power variable is in one optional embodiment the target generator power itself, or in another optional embodiment a variable derived from the target generator power, in particular calculated therefrom or determined therefrom in another manner The dynamics of the closed-loop control device can further advantageously be increased by suitable selection of the target generator power variable.

According to a development of the present invention, it is provided that the closed-loop control device is set up to determine a respective target torque as the first preset variable, as the second preset variable, and as the third preset variable. This represents an embodiment of the closed-loop control device which is both particularly advantageous and easy to operate. A target torque is sometimes also designated as a target moment in the context of the present technical teaching—in particular because of the shorter expression in the original language of the application. The terms “target torque” and “target moment” are in particular to be understood synonymously.

According to a development of the present invention, it is provided that the power controller is set up to determine a power target torque as the first preset variable as a function of the power control deviation. The frequency controller is set up to determine a frequency target torque as the second preset variable as a function of the frequency control deviation. The preselection module is set up to determine a preselection target torque as the third preset variable. The closed-loop control device is set up to combine the power target torque, the frequency target torque, and the preselection target torque with one another to form an overall target torque as the overall preset variable, in particular to add them together. All preset variables are therefore advantageously target torques, and the overall preset variable is also a target torque.

According to a development of the present invention, it is provided that the preselection module is set up to calculate the third preset variable by dividing the target generator power variable by the detected generator frequency, wherein the quotient thus obtained is multiplied by a predetermined constant pre-factor. This represents both a simple and advantageous way of calculating the third preset variable. The predetermined constant pre-factor optionally takes into consideration constants which are necessary or advantageous for the calculation, in particular natural constants. In one optional embodiment, the pre-factor is selected so that a dimensionless representation of the calculation is possible if the input variables are specified in predetermined units.

In particular, the preselection module is optionally set up to calculate the third preset variable Mₛₒₗₗ^{Vor} according to the following equation:

$${M}_{s o l l}^{V o r} = F \frac{{P}_{s o l l}^{g}}{{f}_{G}} , \qquad ( 1 )$$

With the target generator power variable Pₛₒₗₗ^{g}, the detected generator frequency f_{G}, and the predetermined constant pre-factor F.

For the case that the target generator power variable Pₛₒₗₗ^{g} is equal to the target generator power Pₛₒₗₗ, equation (1) can be derived in particular starting from the following relationship between the target generator power Pₛₒₗₗ and the target torque as the third preset variable Mₛₒₗₗ^{Vor}:

Pₛₒₗₗ=Mₛₒₗₗ^{Vor}ω, (2)

with the angular frequency ω.

Equation (2) may be reformulated because of

ω=2πn, (3)

with the speed n, and

n=30f_{G} (4)

to form equation (1), wherein the pre-factor F, with dimensionless notation and specification of the third preset variable in Nm, the speed in min⁻¹, the generator frequency and angular frequency in Hz, and the target generator power in kW, assumes the following value:

$$F = \frac{1000}{π} . \qquad ( 5 )$$

According to a development of the present invention, it is provided that the closed-loop control device is designed as an open-loop control device for direct control of the internal combustion engine. This represents a particularly simple and cost-effective design of the closed-loop control device, wherein in particular no additional open-loop control device beyond the already existing open-loop control device is required. In an optional embodiment, the functionality of the closed-loop control device is implemented in the open-loop control device of the internal combustion engine in the form of a computer program product, i.e., in particular as software. This makes it particularly easy to retrofit an existing open-loop control device with the functionality according to the technical teaching presented here.

The open-loop control device is optionally an engine controller of the internal combustion engine. The open-loop control device is optionally a so-called engine control unit (ECU). The engine controller or the ECU is optionally set up to calculate at least one energization duration for at least one fuel injection valve, in particular an injector, of the internal combustion engine on the basis of the target torque.

If the closed-loop control device is designed as an open-loop control device, in particular an engine controller, and is set up for direct control of the internal combustion engine, it is possible that a speed control of the open-loop control device is active and is used in particular to calculate an energization duration for at least one fuel injection valve, in particular an injector, which is provided for injecting fuel into at least one combustion chamber of the internal combustion engine, in particular depending on the overall target torque calculated as the overall preset variable. However, it is also possible for the energization duration to be calculated from the overall target torque bypassing a speed controller or without using a speed controller. The closed-loop control device in this embodiment is set up in particular to convert the overall preset variable into a control variable, namely the energization duration. The energization duration is the control variable which is then output by the closed-loop control device to control the internal combustion engine.

Alternatively, the closed-loop control device is optionally designed as a—in particular higher-level—generator controller, in particular with an interface to an open-loop control device of the internal combustion engine. In this case, the closed-loop control device optionally has an interface to an open-loop control device of the internal combustion engine. This represents a particularly flexible design of the closed-loop control device. In particular, the closed-loop control device can easily be used with a multiplicity of different existing power assemblies, especially by being connected upstream of an open-loop control device provided there and connected thereto via the interface. The closed-loop control device is optionally set up to output the overall preset variable, in particular to output it to the open-loop control device, i.e., to transmit the overall preset variable via the interface to the open-loop control device. The open-loop control device is optionally set up to calculate at least one energization duration for at least one fuel injection valve on the basis of the overall preset variable.

In particular, a generator controller is understood to mean an open-loop control unit separate, i.e., in particular external, from the open-loop control device of the internal combustion engine, which unit is set up to control the generator, in particular to transmit the overall preset variable as a manipulated variable to the open-loop control device of the internal combustion engine. In particular, a generator controller itself is not an open-loop control unit for the internal combustion engine, especially not a so-called engine control unit (ECU). In particular, the generator controller is provided in addition to the open-loop control device for the internal combustion engine, i.e., in addition to the open-loop control unit. The fact that the generator controller is optionally higher-level means that it is optionally connected upstream of the open-loop control device.

If the closed-loop control device designed as a—in particular higher-level—generator controller is used in combination with an open-loop control device of the internal combustion engine, the open-loop control device is optionally operated with deactivated speed control or without speed control. In an optional embodiment, however, a final idling speed controller is activated in the open-loop control device. When the final idling speed controller is active, the speed of the internal combustion engine is subject to closed-loop control when the engine speed falls below a lower limit speed or exceeds an upper limit speed. Between the lower limit speed and the upper limit speed, the target torque used in the open-loop control device corresponds to the overall target torque specified by the generator controller and transmitted via the interface. In particular, a torque specification of the open-loop control device is activated in this configuration.

A suitable final idling speed controller is disclosed in particular in DE 102 48 633 B4.

In one embodiment, the closed-loop control device designed as an—in particular higher-level—generator controller is set up to receive a maximum target torque from the open-loop control device. In particular, the interface of the closed-loop control device to the open-loop control device is set up to receive the maximum target torque from the open-loop control device.

The closed-loop control device is—independently of its design as an open-loop control device or as an in particular higher-order generator controller—optionally set up to limit at least one preset variable, selected from a group consisting of the first preset variable, the second preset variable, the third preset variable, and the overall preset variable, to a maximum target torque, in particular the maximum target torque received from the open-loop control device or a maximum target torque determined by the closed-loop control device itself. The closed-loop control device is optionally set up to limit at least one preset variable, selected from a group consisting of the first preset variable, the second preset variable, and the third preset variable, to the maximum target torque. The closed-loop control device is optionally set up to limit at least one preset variable, selected from a group consisting of the first preset variable and the second preset variable, to the maximum target torque. The closed-loop control device is optionally set up to limit the first preset variable, the second preset variable, and the overall preset variable to the maximum target torque, in particular to the same maximum target torque. The closed-loop control device is optionally set up to limit the first preset variable and the second preset variable to the maximum target torque, in particular to the same maximum target torque. The power controller is optionally set up to limit the first preset variable to the maximum target torque. Alternatively or additionally, the frequency controller is set up to limit the second preset variable to the maximum target torque.

In one optional embodiment, the power controller is set up to limit its integral component to the maximum target torque. In particular, the power controller is set up to limit its integral component and the first preset variable to the maximum target torque, in particular to the same maximum target torque. In particular, the integral component on the one hand and the first preset variable on the other hand are limited separately here to the maximum target torque. In particular, the power controller is optionally set up to limit its integral component and the first preset variable to the same maximum target torque, to which the overall preset variable is also limited at the same time. In particular, the controller output of the power controller and its integral component are thus limited to the same value.

In one optional embodiment, the frequency controller is set up to limit its integral component to the maximum target torque. In particular, the frequency controller is set up to limit its integral component and the second preset variable to the maximum target torque, in particular to the same maximum target torque. In particular, the integral component on the one hand and the second preset variable on the other hand are limited separately here to the maximum target torque. In particular, the frequency controller is optionally set up to limit its integral component and the second preset variable to the same maximum target torque, to which the overall preset variable is also limited at the same time. In particular, the controller output of the frequency controller and its integral component are thus limited to the same value.

According to a development of the present invention, it is provided that the power controller is set up to calculate a first preset variable additional term from the target generator power by way of a first calculation element which has a differential—or differentiating—transmission behavior, and to offset the first preset variable additional term with a first precursor preset variable calculated by the power controller—in particular depending on the power control deviation—in order to obtain the first preset variable. In this way, the control behavior can advantageously be designed to be particularly dynamic. In particular, the load switching behavior of a power assembly including the closed-loop control device is improved. In particular, a frequency dip in the generator frequency is advantageously reduced in the event of a load connection.

In an optional embodiment, the first calculation element is a D element or a DT₁ element.

According to one embodiment of the closed-loop control device, the power controller is set up to add the first preset variable additional term to the first precursor preset variable in order to obtain the first preset variable. This is a particularly simple way of calculating the first preset variable, taking into account the preset variable additional term.

According to a development of the present invention, it is provided that the preselection module is set up to calculate a second precursor preset variable, in particular as a static third preset variable, from the target generator power variable and the detected generator frequency, and to calculate the third preset variable from the second precursor preset variable, i.e., in particular from the static third preset variable, by way of a second calculation element, which has a proportional and a differential transmission behavior, wherein the third preset variable is calculated in particular as a dynamic third preset variable. The closed-loop control is also designed very dynamically in this way and the load switching behavior is improved.

The second precursor preset variable is optionally calculated according to equation (1) and results therefrom in particular as a static target torque, wherein the third preset variable is then calculated therefrom by the second calculation element as a dynamic target torque.

In an optional embodiment, the second calculation element is a PD element or a (PD)T₁ element.

According to a development of the present invention, it is provided that the preselection module is set up to calculate the target generator power variable from the target generator power as a static target generator power by way of a third calculation element, which has a proportional and differential transmission behavior. The target generator power variable is then in particular a dynamic target generator power in an optional embodiment. The closed-loop control is also designed very dynamically in this way and the load switching behavior is improved. This embodiment is particularly advantageous in that the dynamic amplification of the—static—target generator power is independent of the behavior of the detected generator frequency. A change of the detected generator frequency counter to the change of the target generator power at the moment of load switching therefore cannot have a negative effect on the load switching behavior.

In an optional embodiment, the third calculation element is a PD element or a (PD)T₁ element.

The present invention also provides a closed-loop control arrangement for closed-loop control of a power assembly including an internal combustion engine and a generator having an operative drive connection to the internal combustion engine, said arrangement having a closed-loop control device according to the present invention designed as an—in particular higher-level—generator controller or a closed-loop control device according to one or more of the previously described embodiments designed as an—in particular higher-level—generator controller, wherein the closed-loop control arrangement has an open-loop control device operatively connected to the closed-loop control device for directly controlling the internal combustion engine, and wherein the closed-loop control device is set up to transfer the overall preset variable to the open-loop control device. In particular, the advantages which have already been explained in conjunction with the closed-loop control device are provided in conjunction with the closed-loop control arrangement.

The open-loop control device is optionally operable with deactivated speed control or without speed control or it has no speed control. The open-loop control device optionally has a final idling speed controller. The open-loop control device is optionally operable with torque preset. The open-loop control device is optionally set up to determine, in particular to calculate, a maximum target torque and to output the maximum target torque, in particular to transmit the maximum target torque to the closed-loop control device. The open-loop control device is optionally set up to calculate the maximum target torque as a function of at least one engine variable of the internal combustion engine, in particular an instantaneous speed or an instantaneous charge pressure.

The present invention also provides a power assembly which has an internal combustion engine and a generator having an operative drive connection to the internal combustion engine. The power assembly also has a closed-loop control device according to the present invention or a closed-loop control device according to one or more of the embodiments described above, or the power assembly has a closed-loop control arrangement according to the present invention or a closed-loop control arrangement according to one or more of the previously described embodiments. The closed-loop control device or the closed-loop control arrangement is operatively connected to the internal combustion engine and the generator of the power assembly. In particular, the advantages which have already been explained in conjunction with the closed-loop control device and the closed-loop control arrangement are provided in conjunction with the power assembly.

The present invention also provides a method for closed-looped control of a power assembly, which has an internal combustion engine and a generator having an operative drive connection to the internal combustion engine, wherein a generator power of the generator is detected as a controlled variable, wherein a power control deviation is determined as the difference between the detected generator power and a target generator power, and wherein a first preset variable is determined as a function of the power control deviation. In addition, a generator frequency of the generator is detected as a controlled variable, wherein a frequency control deviation is determined as the difference between the detected generator frequency and a target generator frequency, and wherein a second preset variable is determined as a function of the frequency control deviation. In addition, a third preset variable is determined—in particular as a preselection variable for controlling the internal combustion engine. The first preset variable, the second preset variable, and the third preset variable are combined, in particular offset, with one another to form an overall preset variable, and the overall preset variable is used—in particular as a manipulated variable—for controlling the internal combustion engine. In particular, the internal combustion engine is controlled using the overall preset variable. In particular, the advantages which have already been explained in conjunction with the closed-loop control device, the closed-loop control arrangement, and the power assembly result in conjunction with the method. Optionally, the method includes at least one method step which has been explicitly or implicitly explained in conjunction with the closed-loop control device, the closed-loop control arrangement, and/or the power assembly.

Optionally, the first preset variable, the second preset variable, and the third preset variable are added to one another to form the overall preset variable.

Optionally, the third preset variable is determined on the basis of the target generator power variable. Optionally, the third preset variable is determined on the basis of the target generator power variable and the detected generator frequency.

Optionally, a target torque is determined in each case as the first preset variable, as the second preset variable, and as the third preset variable.

Optionally, a power target torque as a function of the power control deviation is determined as the first preset variable, a frequency target torque as a function of the frequency control deviation is determined as the second preset variable, and a preselection target torque is determined as the third preset variable. The power target torque, the frequency target torque, and the preselection target torque are combined, in particular added, to one another to form an overall target torque as the overall preset variable.

The third preset variable is optionally calculated by dividing the target generator power variable by the detected generator frequency, wherein the quotient thus obtained is multiplied by a predetermined constant pre-factor. In particular, the third preset variable is calculated according to equation (1).

Optionally, a first preset variable additional term is calculated from the target generator power by way of a first calculation element which has a differential transmission behavior, and the first preset variable additional term is offset with a first precursor preset variable calculated on the basis of the power control deviation, in particular added to the first precursor preset variable, by which the first preset variable is obtained.

Optionally, a second precursor preset variable is calculated from the target generator power variable and the detected generator frequency, and the third preset variable is calculated from the second precursor preset variable by way of a second calculation element, which has a proportional and differential transmission behavior.

Optionally, the target generator power variable is calculated from the target generator power by way of a third calculation element which has a proportional and differential transmission behavior.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic representation of a first exemplary embodiment of a power assembly with a first exemplary embodiment of a closed-loop control arrangement and a first exemplary embodiment of a closed-loop control device;

FIG. 2 shows a schematic representation of a second exemplary embodiment of a power assembly with a second exemplary embodiment of a closed-loop control device;

FIG. 3 shows a schematic detailed representation of the first exemplary embodiment of the power assembly;

FIG. 4 shows a schematic detailed representation of the second exemplary embodiment of the power assembly;

FIG. 5 shows a schematic detailed representation of the closed-loop control device;

FIG. 6 shows a schematic detailed representation of a third exemplary embodiment of a power assembly with a third exemplary embodiment of a closed-loop control device;

FIG. 7 shows a schematic representation of a fourth exemplary embodiment of a power assembly with a fourth exemplary embodiment of a closed-loop control device;

FIG. 8 shows a schematic representation of a fifth exemplary embodiment of a power assembly with a fifth exemplary embodiment of a closed-loop control device; and

FIG. 9 shows a schematic, diagrammatic representation of the mode of operation of a method for closed-loop control of a power assembly.

Corresponding reference characters indicate corresponding parts throughout the several views. The exemplification set out herein illustrate embodiments of the invention, and such exemplifications are not to be construed as limiting the scope of the invention in any manner

### DETAILED DESCRIPTION OF THE INVENTION

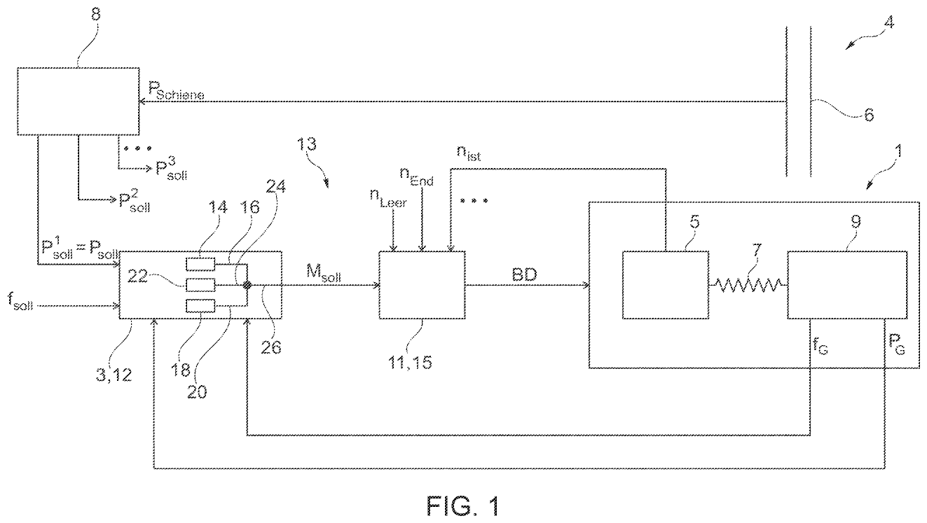

FIG. 1 shows a schematic representation of a first exemplary embodiment of a power assembly 1 with a first exemplary embodiment of a closed-loop control arrangement 13 and a first exemplary embodiment of a closed-loop control device 3. The power assembly 1 in this exemplary embodiment is part of a higher-level network of a multiplicity of power assemblies, of which only the one power assembly 1 considered in greater detail here is shown. In particular, the power assembly 1 is electrically connected to a power grid 4, here specifically to a busbar 6. In particular, the power assembly 1 can be operated in island parallel operation or in grid parallel operation; in particular, the power grid 4 can be a local power grid, in particular an on-board electrical system of a vehicle, for example a ship, or a supra-regional power grid. An external open-loop control unit 8 is assigned to the power grid 4 and distributes a total power P_{Schiene} requested at the busbar 6, which is also referred to as the total load, across the individual power assemblies 1, in particular by calculating a separate target generator power Pₛₒₗₗ¹, Pₛₒₗₗ², Pₛₒₗₗ³, etc. for each power assembly 1. A first target generator power Pₛₒₗₗ¹ assigned to the power assembly 1 specifically shown here is referred to in the following as the target generator power Pₛₒₗₗ for short for the sake of simplicity.

However, the power assembly 1 can also be operated in isolation.

It is also possible that the power distribution is not carried out in an external open-loop control unit 8, but in the closed-loop control device 3 itself, in particular in a master closed-loop control device of one of the power assemblies 1, wherein the other closed-loop control devices 3 of the other power assemblies 1 are then optionally operated as slave closed-loop control devices, which receive their respective target generator power from the master closed-loop control device.

The power assembly 1 has an internal combustion engine 5 and a generator 9 which has an operative drive connection to the internal combustion engine 5 via a shaft 7 shown schematically. The closed-loop control device 3 is operatively connected to the internal combustion engine 5 on the one hand and to the generator 9 on the other. In particular, the generator 9 is electrically connected to the busbar 6 in a manner not presented explicitly here.

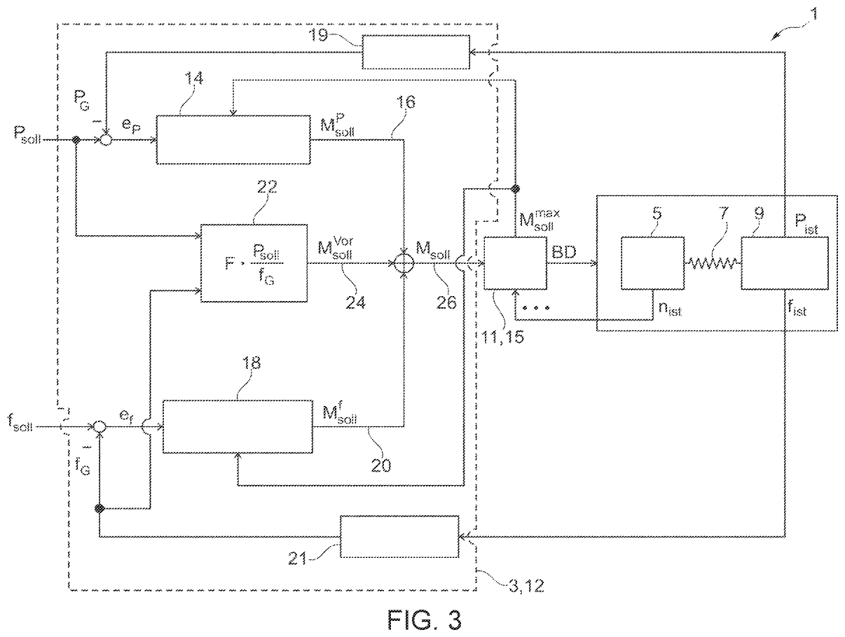

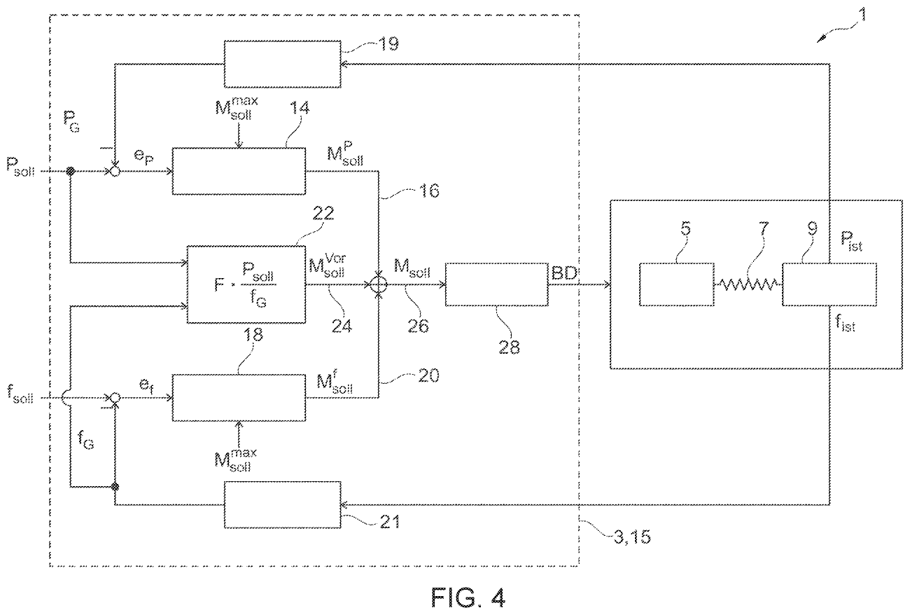

In particular, the closed-loop control device 3 is set up—compare also FIGS. 3 and 4 in this regard—for closed-loop control of the power assembly 1, wherein it has a power controller 14 which is set up to detect a generator power P_{G} of the generator 9 as a first controlled variable, to determine a power control deviation e_{P} as the difference between the detected generator power P_{G} and the target generator power Pₛₒₗₗ, and to determine a first preset variable 16 as a manipulated variable for controlling the internal combustion engine 5 as a function of the power control deviation e_{P}. In addition, the closed-loop control device 3 has a frequency controller 18, which is set up to detect a generator frequency f_{G} of the generator 9 as a second controlled variable, to determine a frequency control deviation of as the difference between the detected generator frequency f_{G} and the target generator frequency fₛₒₗₗ, and to determine a second preset variable as a manipulated variable for controlling the internal combustion engine 5 as a function of the frequency control deviation e_{f}. The closed-loop control device 3 additionally has a preselection module 22, which is set up to determine a third preset variable 24 in particular as a preselection variable for controlling the internal combustion engine 5. The closed-loop control device 3 is set up to combine, in particular to offset, the first preset variable 16, the second preset variable 20, and the third preset variable 24 with one another to form an overall preset variable 26, and to use, in particular to output, the overall preset variable 26 as a manipulated variable for controlling the internal combustion engine 5. In particular, the first preset variable 16, the second preset variable 20, and the third preset variable 24 are added to one another, by which the overall preset variable 26 is obtained.

The closed-loop control device 3 enables a dynamic load switching behavior and at the same time a robust closed-loop control of both the generator frequency and the generator power. The dynamics are provided here by the preselection module 22, while the first preset variable 16 and the second preset variable 20 are added correctively to ensure a stable closed-loop control.

The overall preset variable 26 in the first exemplary embodiment described here is in particular a target torque Mₛₒₗₗ, which is also designated as the overall target torque. Accordingly, each of the first, second, and third preset variables 16, 20, and 24 is optionally also a torque.

The closed-loop control device 3 is designed as a generator controller 12 according to the first exemplary embodiment shown here and is operatively connected to an open-loop control device 11 of the internal combustion engine 5 in such a way that the overall preset variable 26 can be transmitted from the closed-loop control device 3 to the open-loop control device 11. This also enables, at the same time, particularly robust closed-loop control and versatile usability of the closed-loop control device 3, in particular with a multiplicity of power assemblies 1.

The closed-loop control device 3 and the open-loop control device 11 together form the closed-loop control arrangement 13 for control of the power assembly 1. The open-loop control device 11 is optionally designed as an engine controller 15, in particular as an engine control unit (ECU).

From the target torque Mₛₒₗₗ, the open-loop control device 11—optionally as a function of further engine variables, in particular a detected speed nᵢₛₜ—calculates an energization duration BD for controlling fuel injection valves of the internal combustion engine 5.

A speed controller of the open-loop control device 11 is optionally deactivated. Optionally, a final idling speed controller of the open-loop control device 11 is activated. This is used to control the speed of the internal combustion engine 5 if the detected speed nᵢₛₜ falls below a lower speed limit n_{Leer} or exceeds an upper speed limit n_{End}. Between these speed limits, a target torque calculated in the open-loop control device 11 is equal to the target torque Mₛₒₗₗ specified by the closed-loop control device 3. In particular, a torque specification is activated in the open-loop control device 11.

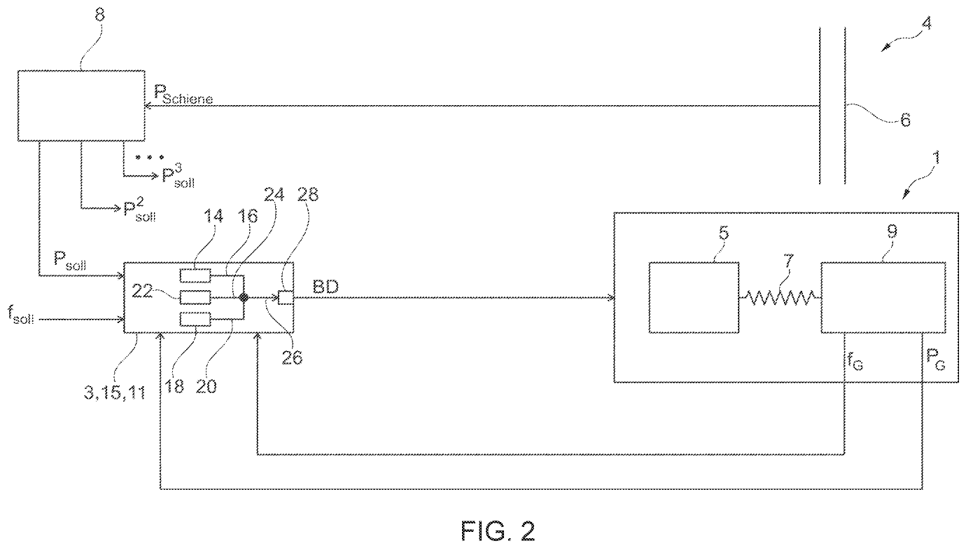

FIG. 2 shows a schematic representation of a second exemplary embodiment of a power assembly 1 with a second exemplary embodiment of a closed-loop control device 3.

Like and functionally similar elements are provided with the same reference signs in all figures, and therefore reference is made to the previous description in each case.

In this exemplary embodiment the closed-loop control device 3 itself is designed as an open-loop control device 11, in particular an engine controller 15, for direct, in particular immediate, control of the internal combustion engine 5. In particular, the closed-loop control device 3 is set up to calculate, by way of a calculation element 28, an energization duration BD for controlling the injectors of the internal combustion engine 5 from the overall preset variable 26 calculated internally by the closed-loop control device 3, in particular the target torque Mₛₒₗₗ.

FIG. 3 shows a schematic detailed representation of the first exemplary embodiment of the power assembly 1. The closed-loop control device 3 is optionally set up to filter an instantaneous actual power Pᵢₛₜ of the generator 9 in a power filter 19 and to use the filtered actual power Pᵢₛₜ as the detected generator power P_{G}. According to an optional embodiment, the power filter 19 is a PT₁ filter or a mean value filter.

The closed-loop control device 3 is additionally set up to filter an instantaneous actual frequency fᵢₛₜ of the generator 9 in a frequency filter 21 and to use the filtered actual frequency fᵢₛₜ as the detected generator frequency f_{G}. According to an optional embodiment, the frequency filter 21 is a PT₁ filter or a mean value filter. In an optional embodiment, the frequency filter 21 is also set up to limit the instantaneous actual frequency fᵢₛₜ or the filtered actual frequency fᵢₛₜ in particular to a predetermined minimum frequency as the lower limit. However, the limiting of the generator frequency can also take place at another point in the closed-loop control device 3. In particular, it is possible that corresponding limiting is only carried out for the preselection module 22 or in the preselection module 22.

The preselection module 22 is set up in particular to calculate the third preset variable 24 on the basis of equation (1) (here with Pₛₒₗₗ^{g}=Pₛₒₗₗ).

The closed-loop control device 3 is set up in particular to add the first preset variable 16, the second preset variable 20, and the third preset variable 24 to form the overall preset variable 26.

In the exemplary embodiment shown here, the closed-loop control device 3 is designed as a higher-level generator controller 12. The open-loop control device 11 designed as the engine controller 15 is set up to determine, in particular to calculate, a maximum target torque Mₛₒₗₗ^{max}, in particular as a function of at least one engine variable of the internal combustion engine 5, in particular of its instantaneous speed and the instantaneous charge air pressure, and to transmit the maximum target torque Mₛₒₗₗ^{max} to the closed-loop control device 3. The closed-loop control device 3 is set up in particular to receive the maximum target torque Mₛₒₗₗ^{max} from the open-loop control device 11. The power controller 14 is set up to limit the first preset variable 16 and optionally its integral component to the maximum target torque Mₛₒₗₗ^{max}. The frequency controller 18 is optionally set up to limit the second preset variable 20, optionally its integral component, to the maximum target torque Mₛₒₗₗ^{max}.

The closed-loop control device 3 is set up in particular to determine a target torque in each case as the first preset variable 16, the second preset variable 20, and the third preset variable 24.

In particular, the power controller 14 is set up to determine a power target torque Mₛₒₗₗ^{P} as the first preset variable 16 as a function of the power control deviation e_{P}. The frequency controller 18 is set up to determine a frequency target torque Mₛₒₗₗ^{f} as the second preset variable 20 as a function of the frequency control deviation e_{f}. The preselection module 22 is set up to determine the preselection target torque Mₛₒₗₗ^{Vor} as the third preset variable 24. The closed-loop control device 3 is set up to combine, in particular to add, the power target torque Mₛₒₗₗ^{P}, the frequency target torque Mₛₒₗₗ^{f}, and the preselection target torque Mₛₒₗₗ^{Vor} with one another to form the overall target torque Mₛₒₗₗ as the overall preset variable 26.

FIG. 4 shows a schematic detailed representation of the second exemplary embodiment of the power assembly 1. The mode of operation of the closed-loop control device 3 designed as the engine controller 15 in this exemplary embodiment is the same as the mode of operation of the closed-loop control device 3 explained in conjunction with FIG. 3, wherein the energization duration BD is calculated directly in the closed-loop control device 3 from the target torque Mₛₒₗₗ, however, i.e., from the overall preset variable 26, by way of a calculation element 28. In addition, the maximum target torque Mₛₒₗₗ^{max} is available directly in the closed-loop control device 3 or is calculated by this itself here.

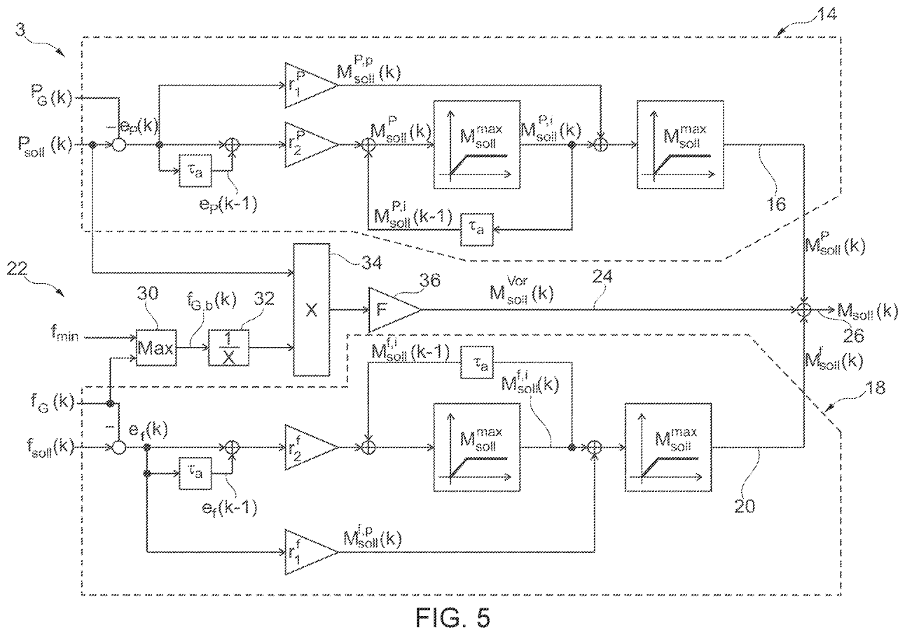

FIG. 5 shows a schematic detailed representation of the closed-loop control device 3. In particular the mode of operation of the power controller 14, the frequency controller 18, and the preselection module 22 are shown here.

The mode of operation is represented in a time-discrete representation, wherein the sampling steps are designated by a running index. The index value of the running index indicated by k corresponds to an instantaneous sampling step. Accordingly, the index value indicated by k−1 denotes the sampling step immediately before the sampling step denoted by k.

The control algorithms for the power controller 14 and the frequency controller 18 are designed as PI controllers. Alternatively, however, it is also possible that at least one of the controllers, selected from the power controller 14 and the frequency controller 18, is designed as a PID controller or as a PI(DT₁) controller.

The power controller 14 calculates the power control deviation e_{P}(k) from the target generator power Pₛₒₗₗ(k) and the detected generator power P_{G}(k) in the current sampling step k, and, from this, a power proportional component Mₛₒₗₗ^{P,p}(k), by multiplying the power control deviation e_{P}(k) by a first power constant r₁^{P}. The first power constant r₁^{P} is optionally equal to an optionally parameterizable, i.e., predeterminable power proportional coefficient kₚ^{P}. The power controller 14 also calculates a power integral component Mₛₒₗₗ^{P,i}(k) using the trapezoidal rule for integration by adding the power control deviation e_{P}(k) of the current sampling step k to the power control deviation e_{P}(k−1) of the previous sampling step k−1, wherein the sum thus formed is multiplied by a second power constant r₂^{P}, wherein the product thus formed is added to the preceding power integral component Mₛₒₗₗ^{P,i}(k−1) delayed by one sampling step tₐ, and wherein the sum in turn formed in this way is delimited upward to the maximum target torque Mₛₒₗₗ^{max}. The power integral component Mₛₒₗₗ^{P,i}(k) thus calculated is added to the power proportional component Mₛₒₗₗ^{P,p}(k), wherein the sum formed in this way is again delimited upward to the maximum target torque Mₛₒₗₗ^{max}. This results in the first preset variable 16, in this case the target torque Mₛₒₗₗ^{P}(k) of the power controller 14.

The second power constant r₂^{p} is optionally given by:

$${r}_{2}^{P} = \frac{{k}_{p}^{P} {τ}_{a}}{2 {τ}_{N}} , \qquad ( 6 )$$

with the parameterizable power proportional coefficient kₚ^{P}, the time width τₐ of a sampling step, and the parameterizable reset time τ_{N}.

The frequency controller 18 calculates the frequency control deviation e_{f}(k) from the target generator frequency fₛₒₗₗ(k) and the detected generator frequency f_{G}(k) in the current sampling step k, and, from this, a frequency proportional component Mₛₒₗₗ^{f,p}(k), by multiplying the frequency control deviation e_{f}(k) by a first frequency constant r₁^{f}. The first frequency constant rᵢ^{f} is optionally equal to an optionally parameterizable, i.e., predeterminable frequency proportional coefficient kₚ^{f}. The frequency controller 18 also calculates a frequency integral component Mₛₒₗₗ^{f,i}(k), using the trapezoidal rule for integration by adding the frequency control deviation e_{f}(k) of the current sampling step k to the frequency control deviation e_{f}(k−1) of the previous sampling step k−1, wherein the sum thus formed is multiplied by a second frequency constant r₂^{f}, wherein the product thus formed is added to the preceding frequency integral component Mₛₒₗₗ^{f,i}(k−1) delayed by one sampling step tₐ, and wherein the sum in turn formed in this way is delimited upward to the maximum target torque Mₛₒₗₗ^{max}. The frequency controller 18 adds the frequency integral component Mₛₒₗₗ^{f,i}(k) thus calculated to the frequency proportional component Mₛₒₗₗ^{f,p}(k), and again delimits the sum formed in this way upward to the maximum target torque Mₛₒₗₗ^{max}. This then results in the second preset variable 20, in this case the target torque Mₛₒₗₗ^{f}(k) of the frequency controller 18.

The second frequency constant r₂^{f} is optionally given by:

$${r}_{2}^{f} = \frac{{k}_{p}^{f} {τ}_{a}}{2 {τ}_{N}} , \qquad ( 7 )$$

with the parameterizable frequency proportional coefficient kₚ^{f}, the time width τₐ of a sampling step, and the parameterizable reset time τ_{N}.

The preselection module 22 is optionally set up to limit the detected generator frequency f_{G}(k) to a predetermined minimum frequency fₘᵢₙ by way of a limiting element 30, wherein the limiting element 30 selects and passes on as the limited detected generator frequency f_{G,b}(k) in particular the maximum of the detected generator frequency f_{G}(k) and the predetermined minimum frequency fₘᵢₙ. The reciprocal of the limited detected generator frequency f_{G,b}(k) is then calculated in a reciprocal element 32 and this reciprocal is multiplied in a first multiplication element 34 by a target generator power variable f_{G,b}(k), in the exemplary embodiment shown here by the target generator power Pₛₒₗₗ(k). The product thus calculated is then multiplied in a second multiplication element 36 by the predetermined constant pre-factor F, from which the third preset variable 24 results as the preselection target torque Mₛₒₗₗ^{Vor}(k). The third preset variable 24 is thus calculated essentially according to equation (1), wherein in an optional embodiment the limited detected generator frequency f_{G,b}(k) is used as the detected generator frequency f_{G}(k). It is also possible, however, that the detected generator frequency f_{G}(k) is used directly. It is also possible that the limiting of the generator frequency does not take place in the preselection module 22, wherein then the preselection module 22 receives the limited detected generator frequency f_{G,b}(k) as the input variable.

The preselection module 22 is thus set up in particular to determine the third preset variable 24 on the basis of the target generator power variable pₛₒₗₗ^{g}(k) and the detected generator frequency f_{G}(k).

The preselection module 22 is set up in particular to calculate the third preset variable 24 by dividing the target generator power variable Pₛₒₗₗ^{g}(k) by the detected generator frequency f_{G}(k), wherein the quotient thus obtained is multiplied by the predetermined constant pre-factor F.

The closed-loop control device 3 is furthermore set up to combine, in particular to add, the first preset variable 16, the second preset variable 20, and the third preset variable 24 to form the overall preset variable 26, i.e., to combine, in particular to add, the power target torque Mₛₒₗₗ^{P}(k), the frequency target torque Mₛₒₗₗ^{f}(k), and the preselection target torque Mₛₒₗₗ^{Vor}(k) to form the overall target torque Mₛₒₗₗ(k).

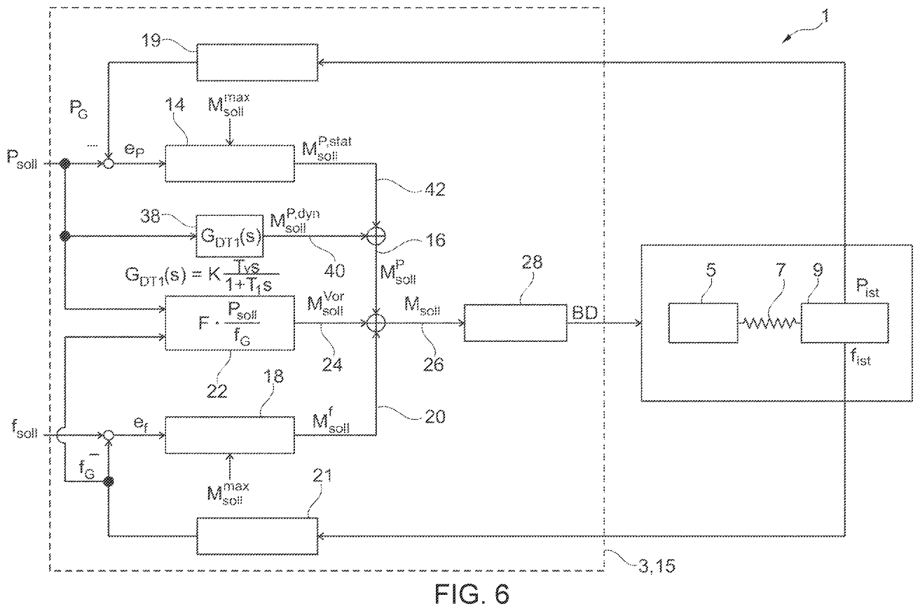

FIG. 6 shows a schematic detailed representation of a third exemplary embodiment of the power assembly 1 with a third exemplary embodiment of a closed-loop control device 3.

In each of the exemplary embodiments of FIGS. 6, 7, and 8, the closed-loop control device 3 is designed as an open-loop control device 11, in particular as an engine controller 15. However, the embodiments of the closed-loop control device 3 shown in these figures can also be implemented just as well in an exemplary embodiment of the closed-loop control device 3 which is designed as a higher-order generator controller 12. The technical teaching of FIGS. 6, 7, and 8 is therefore not restricted to the specific embodiment of the closed-loop control device 3 as the open-loop control device 11 or engine controller 15.

In the third exemplary embodiment of the close-loop control device 3 according to FIG. 6, the power controller 14 is set up to calculate a first preset variable additional term 40, in particular a dynamic power torque Mₛₒₗₗ^{P,dyn}, from the target generator power Pₛₒₗₗ by way of a first calculation element 38 which has a differential transmission behavior, and to offset the first preset variable additional term 40 with a first precursor preset variable 42, in particular a static power target torque Mₛₒₗₗ^{P,stat}, calculated by the power controller 14, in order to obtain the first preset variable 16, in particular the power target torque Mₛₒₗₗ^{P}.

In particular, the closed-loop control device 3 is set up to add the first preset variable additional term 40 to the precursor preset variable 42 in order to obtain the first preset variable 16. In the exemplary embodiment shown here, the first calculation element 38 is a DT₁ element. Alternatively, however, it is also possible for the first calculation element 38 to be designed as a D-element in another exemplary embodiment.

The target power Pₛₒₗₗ is thus amplified by the first calculation element 38 and—in the exemplary embodiment shown here—superimposed additively on the precursor preset variable 42. In this way, the closed-loop control device 3 has an improved, in particular more dynamic load switching behavior.

The embodiment shown here has the advantage over an embodiment in which the power controller 14 would have an overall PI(DT₁) characteristic that only the target power Pₛₒₗₗ is amplified and not the power control deviation e_{P}. If instead a power controller 14 were used that has an overall PI(DT₁) characteristic, the dynamics of the power control would depend on the design of the power filter 19. If, for example, a PT₁ power filter with a small time constant T₁ were selected, this, in combination with the PI(DT₁) characteristic of the power controller 14, would lead to a delayed adaptation to a sudden change in the target generator power Pₛₒₗₗ. Specifically, the detected generator power P_{G} is subtracted from this, and then also changes rapidly when the load changes, in particular fed from the reserve of kinetic energy, in particular rotational energy, of the system consisting of the generator 9, the coupling 7 and the internal combustion engine 5. In particular, the actual generator power Pᵢₛₜ follows an electrical load change almost instantaneously. This means that the target generator power Pₛₒₗₗ and the detected generator power P_{G} change in the same effective direction, so that the power change is only attenuated in the power control deviation e_{P}. The resulting delay is advantageously avoided if—as shown in FIG. 6—the target generator power Pₛₒₗₗ is fed directly to the first calculation element 38.

The first calculation element 38 optionally has the following transfer function:

$${G}_{D {T}_{1}} ( s ) = {K}_{1} \frac{{T}_{V} s}{1 + {T}_{1} s} , \qquad ( 8 )$$

with a factor K₁, the lead time T_{V} and the delay time T₁. The first calculation element 38 is only effective transiently or dynamically, i.e., only in the event of a load change. The preset variable additional term 40 also changes abruptly in the event of a sudden load change and then finally decays to zero. In a steady state, the preset variable additional term 40 is zero. How quickly the preset variable additional term 40 decays depends on the delay time T₁. The factor K₁ is used in particular to convert the physical unit of the input variable, i.e., the target generator power Pₛₒₗₗ, into the physical unit of the output variable, i.e., of the preset variable additional term 40, in particular a torque.

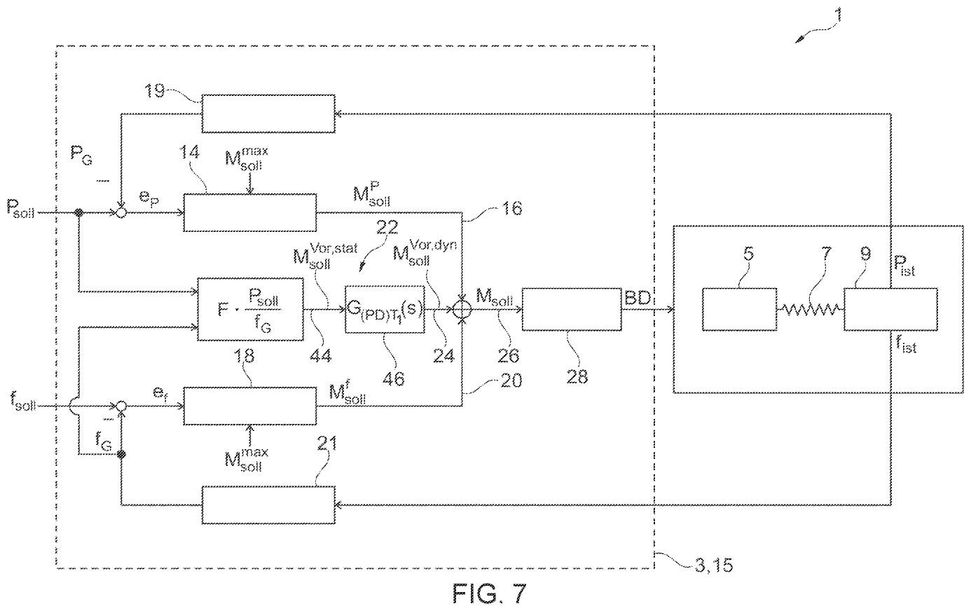

FIG. 7 shows a schematic representation of a fourth exemplary embodiment of a power assembly 1 with a fourth exemplary embodiment of a closed-loop control device 3.

In this fourth exemplary embodiment of the closed-loop control device 3, the preselection module 22 is set up to calculate a second precursor preset variable 44, in particular a static preselection target torque Mₛₒₗₗ^{Vor,stat}, from the target generator power variable Pₛₒₗₗ^{g}, here the target generator power Pₛₒₗₗ, and the detected generator frequency f_{G}, and to calculate the third preset variable 24, namely the preselection target torque Mₛₒₗₗ^{Vor} as a dynamic preselection target torque Mₛₒₗₗ^{Vor,dyn}, from the second precursor preset variable 44 by way of a second calculation element 46 which has a proportional and differential transmission behavior.

The second calculation element 46 is designed in the exemplary embodiment shown here as a (PD)T₁ element, with the following transmission function:

$${G}_{( P D ) {T}_{1}} ( s ) = \frac{1 + {T}_{V} s}{1 + {T}_{1} s} , \qquad ( 9 )$$

with the lead time T_{V} and the delay time T₁. In the stationary case for s=0, the dynamic preselection target torque Mₛₒₗₗ^{Vor,dyn} is thus identical to the static preselection target torque Mₛₒₗₗ^{Vor,stat}. In the dynamic case for s≠0, the static preselection target torque Mₛₒₗₗ^{Vor,stat} is amplified with the aid of a (PD)T₁ characteristic which decays in a stationary manner with the delay time T₁ to the amplification 1.

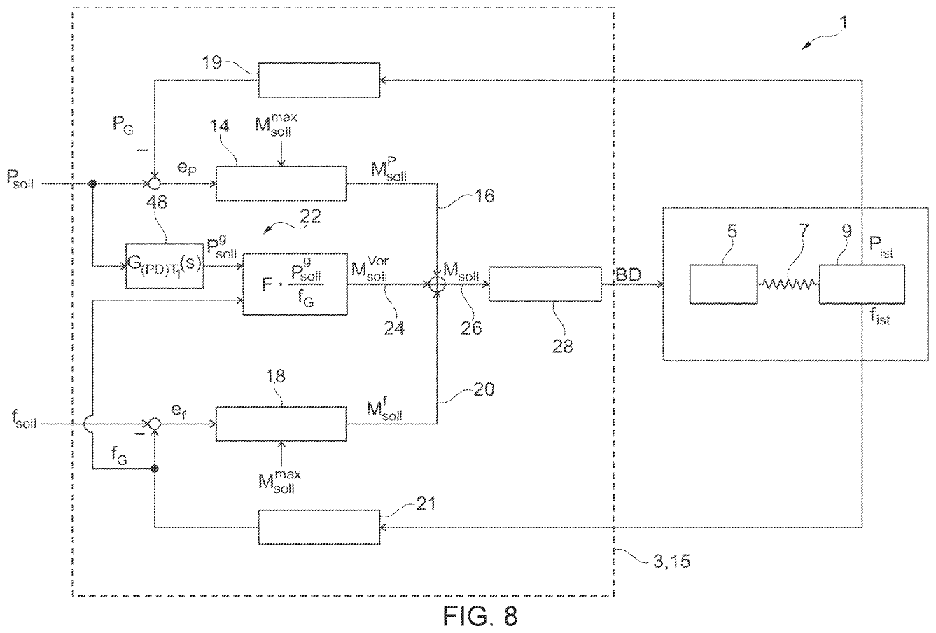

FIG. 8 shows a schematic representation of a fifth exemplary embodiment of a power assembly 1 with a fifth exemplary embodiment of a closed-loop control device 3.

In this exemplary embodiment, the preselection module 22 is set up to calculate the target generator power variable Pₛₒₗₗ^{g}, in particular as a dynamic target generator power Pₛₒₗₗ^{dyn}, from the target generator power Pₛₒₗₗ by way of a third calculation element 48, which has a proportional and differential transmission behavior.

The third calculation element 48 is designed in the exemplary embodiment shown here as a (PD)T₁ element, with the transmission function according to equation (9): In the stationary case for s=0, the target generator variable Pₛₒₗₗ^{g} is thus identical to the target generator power Pₛₒₗₗ. In the dynamic case for s≠0, the target generator power Pₛₒₗₗ is amplified with the aid of a (PD)T₁ characteristic which decays in a stationary manner with the delay time T₁ to the amplification 1.

Changes of the target generator power Pₛₒₗₗ are advantageously amplified here with the aid of the third calculation element 48, and not—as in the exemplary embodiment according to FIG. 7—changes of the quotient of the target generator power Pₛₒₗₗ divided by the detected generator frequency f_{G}. In this embodiment according to FIG. 7, the amplifying effect of the (PD)T₁ element is either attenuated or amplified depending on the direction in which the detected generator frequency f_{G} moves at the moment of the load switching. The amplifying effect of the (PD)T₁ element is advantageously independent of the detected generator frequency f_{G}, in contrast, in the exemplary embodiment according to FIG. 8.

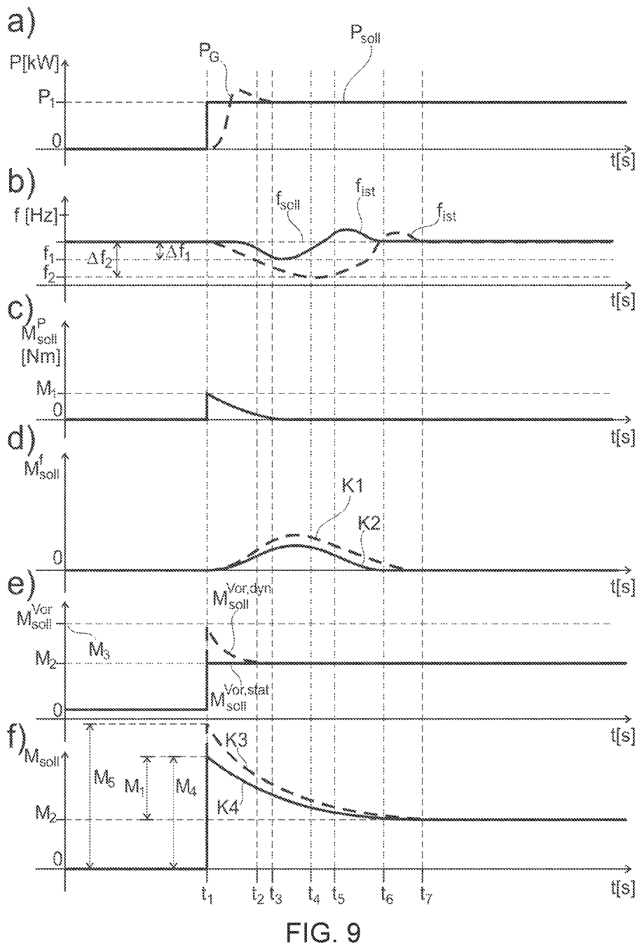

FIG. 9 shows a schematic, diagrammatic representation of the mode of operation of a method for closed-loop control of a power assembly 1. In particular, six time diagrams are shown here.

A first time diagram at a) shows the time curve of the target generator power Pₛₒₗₗ as a solid curve and the time curve of the detected generator power P_{G} as a dashed curve. At a first point in time t₁, the target generator power Pₛₒₗₗ increases suddenly to a first power value P₁ and is subsequently identical to this value. The—filtered—detected generator power P_{G} increases from the first point in time t₁ and finally reaches the target generator power Pₛₒₗₗ at a third point in time t₃.

A third time diagram at c) shows the time curve of the first preset variable 16, namely the power target torque Mₛₒₗₗ^{P}, i.e., the output variable of the power controller 14. Under the assumption of a PI characteristic for the power controller 14, the power target torque Mₛₒₗₗ^{P} suddenly increases at the first point in time t₁ to a first power torque value M₁, which corresponds to the proportional component of the power controller 14 at this point in time. As a result, the power target torque Mₛₒₗₗ^{P} decays up to the third point in time t₃ in a simplified mode of observation to the value 0 Nm, since at this point in time the power control deviation eₚ is also identical to 0 kW and the overall preset variable 26 results as a manipulated variable in large part from the preselection, so that the integral component of the power controller 14 is also approximately identical to 0 kW after the third point in time t₃.

A fourth time diagram at d) shows the time curve of the frequency target torque Mₛₒₗₗ^{f} in the form of a dashed first curve K1 for the case of a static preselection and in the form of a solid second curve K2 for the case of a dynamic preselection.

A fifth time diagram at e) shows the time curve of the static preselection target torque Mₛₒₗₗ^{Vor,stat} as a solid curve and the time curve of the dynamic preselection target torque Mₛₒₗₗ^{Vor,dyn} as a dashed curve. The static preselection target torque Mₛₒₗₗ^{Vor,stat} jumps at the first point in time t₁ to a second preselection torque value M₂, which is calculated according to equation (1); in particular the following applies:

$${M}_{2} = \frac{1000}{π} \frac{{P}_{1}}{{f}_{G}} . \qquad ( 10 )$$

The—filtered—detected generator frequency f_{G} is assumed to be constant for the sake of simplicity, so that the static preselection target torque Mₛₒₗₗ^{Vor,stat} therefore remains at the constant second preselection torque value M₂. The dynamic preselection target torque Mₛₒₗₗ^{Vor,dyn} jumps at the first point in time t₁ to a third preselection torque value M₃ and then decays until it settles at a second point in time t₂ at the value of the static preselection target torque Mₛₒₗₗ^{Vor,stat}. The third preselection target torque M₃ and the decay time are dependent here on the lead time T_{V} and the delay time T₁.

A sixth time diagram at f) represents the time curve of the overall preset variable 26, i.e., the target torque Mₛₒₗₗ, namely once in the form of a solid fourth curve K4 without dynamic preselection, i.e., with static preselection, and once in the form of a dashed third curve K3 with dynamic preselection.

In the case of the static preselection, the overall preset variable 26 jumps at the first point in time t₁ to a fourth preselection torque value M₄, for which the following applies:

M₄=M₁+M2. (11)

The frequency target torque Mₛₒₗₗ^{f} is still identical to 0 Nm at this point in time, since the detected generator frequency f_{G} is still identical to the target generator frequency fₛₒₗₗ. As a result, the overall preset variable 26 decays and has settled at a sixth point in time t₆ to the second preselection torque value M₂ of the static preselection target torque Mₛₒₗₗ^{Vor,stat}. The settling process only ends when the generator frequency has also settled. For this reason, the overall preset variable 26 has settled at a later point in time than the power target torque Mₛₒₗₗ^{P}.

If a dynamic preselection is used, the overall preset variable 26 thus jumps at the first point in time t₁ to a fifth preselection torque value M₅:

M₅=M₁+M₃. (12)

As a result, the overall preset variable 26 decays and has settled at a seventh point in time t₇ to the second preselection torque value M₂ of the static preselection target torque Mₛₒₗₗ^{Vor,stat}.

A second time diagram at b) shows the time curve of the instantaneous actual generator frequency fᵢₛₜ as a dashed curve for the case of the static preselection and as a solid curve for the case of the dynamic preselection. In addition, the target generator frequency fₛₒₗₗ, which is assumed to be constant for the purpose of simplification, is also shown as a dot-dash horizontal line.

In the case of the dynamic preselection, the actual generator frequency fᵢₛₜ only collapses to a first frequency f₁, i.e., only by a first difference value Df₁. The actual generator frequency fᵢₛₜ has in this case already settled at the sixth point in time t₆ at the target generator frequency fₛₒₗₗ.

In contrast, in the case of the static preselection, the actual generator frequency fᵢₛₜ collapses to a second, lower frequency value f₂, i.e., by a second, greater difference value Df₂, and has only settled at the seventh point in time t₇ at the target generator frequency fₛₒₗₗ.

The second time diagram thus shows that the use of a dynamic preselection results in a reduction of the frequency collapse of the generator frequency and a shortening of the settling time.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A closed-loop control device for closed-loop control of a power assembly including an internal combustion engine and a generator having an operative drive connection to the internal combustion engine, the closed-loop control device comprising:
a power controller which is configured for:
detecting a generator power (P_{G}) of the generator as a controlled variable;
determining a power control deviation (e_{P}) as a difference between the generator power (P_{G}) which is detected and a target generator power (Pₛₒₗₗ); and
determining a first preset variable as a function of the power control deviation (e_{P});
a frequency controller which is configured for:
detecting a generator frequency (f_{G}) of the generator as a controlled variable;
determining a frequency control deviation (e_{f}) as a difference between the generator frequency (f_{G}) which is detected and a target generator frequency (fₛₒₗₗ);
determining a second preset variable as a function of the frequency control deviation (e_{f}); and
a preselection module which is configured for determining a third preset variable;
the closed-loop control device being configured for:
combining the first preset variable, the second preset variable, and the third preset variable with one another to form an overall preset variable; and
using the overall preset variable for controlling the internal combustion engine.

2. The closed-loop control device according to claim 1, wherein the closed-loop control device is configured for adding the first preset variable, the second preset variable, and the third preset variable to one another to form the overall preset variable.

3. The closed-loop control device according to claim 1, wherein the preselection module is configured for determining the third preset variable based on a target generator power variable (Pₛₒₗₗ^{g}).

4. The closed-loop control device according to claim 1, wherein the preselection module is configured for determining the third preset variable based on a target generator power variable (Pₛₒₗₗ^{g}) and the generator frequency (f_{G}) which is detected.

5. The closed-loop control device according to claim 1, wherein the closed-loop control device is configured for determining a target torque in each case as the first preset variable, as the second preset variable, and as the third preset variable.

6. The closed-loop control device according to claim 1, wherein the power controller is configured for determining a power target torque (Mₛₒₗₗ^{P}) as a function of the power control deviation (e_{P}) as the first preset variable,
wherein the frequency controller is configured for determining a frequency target torque (Mₛₒₗₗ^{f}) as a function of the frequency control deviation (e_{f}) as the second preset variable,
wherein the preselection module is configured for determining a preselection target torque (Mₛₒₗₗ^{Vor}) as the third preset variable, and
wherein the closed-loop control device is configured for combining the power target torque (Mₛₒₗₗ^{P}), the frequency target torque (Mₛₒₗₗ^{f}), and the preselection target torque (Mₛₒₗₗ^{Vor}) with one another to form an overall target torque (Mₛₒₗₗ) as the overall preset variable.

7. The closed-loop control device according to claim 1, wherein the preselection module is configured for calculating the third preset variable by dividing a target generator power variable (Pₛₒₗₗ^{g}) by the generator frequency (f_{G}) which is detected, and wherein a quotient thus obtained is multiplied by a predetermined constant pre-factor (F).

8. The closed-loop control device according to claim 1, wherein the closed-loop control device is formed as:
an open-loop control device configured for directly controlling the internal combustion engine; or
a generator controller.

9. The closed-loop control device according to claim 8, wherein the closed-loop control device is formed as a generator controller with an interface to an open-loop control device of the internal combustion engine.

10. The closed-loop control device according to claim 1, wherein the power controller is configured for:
calculating a first preset variable additional term from the target generator power (Pₛₒₗₗ) by way of a first calculation element, which has a differential transmission behavior; and
offsetting the first preset variable additional term with a first precursor preset variable calculated by the power controller in order to obtain the first preset variable.

11. The closed-loop control device according to claim 1, wherein the power controller is configured for:
calculating a first preset variable additional term from the target generator power (Pₛₒₗₗ) by way of a first calculation element, which has a differential transmission behavior; and
offsetting the first preset variable additional term with a first precursor preset variable calculated by the power controller—in order to add the first preset variable additional term to the first precursor preset variable—in order to obtain the first preset variable.

12. The closed-loop control device according to claim 1, wherein the preselection module is configured for:
calculating a second precursor preset variable from a target generator power variable (Pₛₒₗₗ^{g}) and the generator frequency (f_{G}) which is detected; and
calculating the third preset variable from a second precursor preset variable by way of a second calculation element, which has a proportional and differential transmission behavior.

13. The closed-loop control device according to claim 1, wherein the preselection module is configured for calculating a target generator power variable (Pₛₒₗₗ^{g}) from the target generator power (Pₛₒₗₗ) by way of a third calculation element, which has a proportional and differential transmission behavior.

14. A closed-loop control arrangement for closed-loop control of a power assembly including an internal combustion engine and a generator having an operative drive connection to the internal combustion engine, the closed-loop control arrangement comprising:
a closed-loop control device which is formed as a generator controller, is for closed-loop control of the power assembly, and includes:
a power controller which is configured for:
detecting a generator power (P_{G}) of the generator as a controlled variable;
determining a power control deviation (e_{P}) as a difference between the generator power (P_{G}) which is detected and a target generator power (Pₛₒₗₗ); and
determining a first preset variable as a function of the power control deviation (e_{P});
a frequency controller which is configured for:
detecting a generator frequency (f_{G}) of the generator as a controlled variable;
determining a frequency control deviation (e_{f}) as a difference between the generator frequency (f_{G}) which is detected and a target generator frequency (fₛₒₗₗ);
determining a second preset variable as a function of the frequency control deviation (e_{f}); and
a preselection module which is configured for determining a third preset variable;
the closed-loop control device being configured for:
combining the first preset variable, the second preset variable, and the third preset variable with one another to form an overall preset variable; and
using the overall preset variable for controlling the internal combustion engine; and
an open-loop control device operatively connected to the closed-loop control device for direct control of the internal combustion engine, the closed-loop control device being configured for transmitting the overall preset variable to the open-loop control device.

15. A power assembly, comprising:
an internal combustion engine;
a generator including an operative drive connection to the internal combustion engine; and
one of:
(a) a closed-loop control device for closed-loop control of the power assembly, the closed-loop control device including:
a power controller which is configured for:
detecting a generator power (P_{G}) of the generator as a controlled variable;
determining a power control deviation (e_{P}) as a difference between the generator power (P_{G}) which is detected and a target generator power (Pₛₒₗₗ); and
determining a first preset variable as a function of the power control deviation (e_{P});
a frequency controller which is configured for:
detecting a generator frequency (f_{G}) of the generator as a controlled variable;
determining a frequency control deviation (e_{f}) as a difference between the generator frequency (f_{G}) which is detected and a target generator frequency (fₛₒₗₗ);
determining a second preset variable as a function of the frequency control deviation (e_{f}); and
a preselection module which is configured for determining a third preset variable;
the closed-loop control device being configured for:
combining the first preset variable, the second preset variable, and the third preset variable with one another to form an overall preset variable; and
using the overall preset variable for controlling the internal combustion engine; and
(b) a closed-loop control arrangement for closed-loop control of the power assembly, the closed-loop control arrangement including:
a closed-loop control device which is formed as a generator controller, is for closed-loop control of the power assembly, and includes:
a power controller which is configured for:
detecting a generator power (P_{G}) of the generator as a controlled variable;
determining a power control deviation (e_{P}) as a difference between the generator power (P_{G}) which is detected and a target generator power (P so ra); and
determining a first preset variable as a function of the power control deviation (e_{P});
a frequency controller which is configured for:
detecting a generator frequency (f_{G}) of the generator as a controlled variable;
determining a frequency control deviation (e_{f}) as a difference between the generator frequency (f_{G}) which is detected and a target generator frequency (fₛₒₗₗ);
determining a second preset variable as a function of the frequency control deviation (e_{f}); and
a preselection module which is configured for determining a third preset variable;
the closed-loop control device being configured for:
combining the first preset variable, the second preset variable, and the third preset variable with one another to form an overall preset variable; and
using the overall preset variable for controlling the internal combustion engine; and
an open-loop control device operatively connected to the closed-loop control device for direct control of the internal combustion engine, the closed-loop control device being configured for transmitting the overall preset variable to the open-loop control device;
wherein the closed-loop control device or the closed-loop control arrangement is operatively connected to the internal combustion engine and the generator of the power assembly.

16. A method for closed-loop control of a power assembly including an internal combustion engine and a generator having an operative drive connection to the internal combustion engine, the method comprising the steps of:
detecting a generator power (P_{G}) of the generator as a controlled variable;
determining a power control deviation (e_{P}) as a difference between the generator power (P_{G}) which is detected and a target generator power (Pₛₒₗₗ);
determining a first preset variable as a function of the power control deviation (e_{P});
detecting a generator frequency (f_{G}) of the generator as a controlled variable;
determining a frequency control deviation (e_{f}) as a difference between the generator frequency (f_{G}) which is detected and a target generator frequency (fₛₒₗₗ);
determining a second preset variable as a function of the frequency control deviation (e_{f});
determining a third preset variable;
offsetting the first preset variable, the second preset variable, and the third preset variable with one another to form an overall preset variable; and
using the overall preset variable for controlling the internal combustion engine.
